(19) United States
(12) Patent Application Publication
(10) Pub. No.: US 2005/0005306 A1
(43) Pub. Date: Jan. 6, 2005

(54) Television portal services system and method using message-based protocol

(76) Inventors: Young-Jip Kim, Suwon-city (KR); Ki-Yeon Sung, Suwon-city (KR); Seung-Mi Kang, Yongin-city (KR); Young-Seop Han, Suwon-city (KR)

Correspondence Address: Robert E. Bushnell;Suite 300, 1522 K Street, N.W., Washington, DC, 20005-1202, US

(21) Appl. No.: 10/871,275

(22) Filed: Jun. 21, 2004

(30) Foreign Application Priority Data
Jul. 4, 2003 (KR) 2003-45451

(51) Int. Cl. H04N 7/173; H04N 7/16

(52) U.S. Cl. 725/131; 725/139

(57) ABSTRACT

A television (TV) portal services apparatus and method using a message-based protocol that allows management and control for various service items by providing a consistent message-based framework in the TV portal service. Further, it is possible to implement new applications by providing a tool for association between individual services, resulting in technical efficiency in implementing a server as well as a terminal, and implementation of flexible services by standardizing an Application Program Interface (API) for the TV portal service.

### CLAIM OF PRIORITY

This application makes reference to, incorporates the same herein, and claims all benefit accruing under 35 U.S.C § 119 from my application TV PORTAL SERVICES SYSTEM AND METHOD USING THE MESSAGE-BASED PROTOCOL earlier field with the Korea Industrial Property Office on Jul. 4, 2003 and there duly assigned serial No. 10-2003-0045451.

### BACKGROUND OF THE INVENTION

1. Field of the Invention

The present invention generally relates to a television (e.g., digital television) portal services system and a method and, more particularly, to a television (TV) portal services system and a method using a message-based protocol as a framework considering service control, user management and inter-service association in implementing a home portal service.

2. Description of the Related Art

In general, DTV (Digital Television) provides a chance capable of opening a service field having a new concept of a combination with data communication as well as a goal of improving picture and sound qualities of a conventional analog television.

Recently, related industry has been intensively attracted to a home living information/media service based on a television (TV) dedicated portal site using a high resolution of picture quality and a network, as having broad applicability.

A scope of the home portal service has been extended over a variety of fields including a messenger service, a multimedia service such as VOD (Video On Demand), a broadcast service, and a commerce service as well as a simple life information service, each service varying in type, dependent on their application object, advanced technique, or business characteristic. A service providing terminal and a server need a structural/technical scheme to cope with each service request properly.

### SUMMARY OF THE INVENTION

The present invention is conceived to solve known problems existing in current television portal service systems, and to provide a television portal services system and a method using a message-based protocol, which is capable of providing a collective service from a user's system log-on (login) to each service utilization and management, a message service itself and a log-off by using a message-based protocol to incorporate respective individual services in configuring a television portal service.

According to an embodiment of the present invention for achieving the above object, there is provided a client terminal device for providing a television portal service, including: at least one or more service applications for performing a plurality of portal services based on a service message received from a server according to a user's request; and a messaging client module for: a) converting a service request message generated from the plurality of service applications to a message frame format through a message-based protocol to transmit to the server via a network, and b) receiving the message frame format for the service message transmitted via the server, parsing the received message frame format, and providing the parsed service message for a service application corresponding to the relevant service message of the plurality of service applications.

According to another embodiment of the present invention, there is provided a system for providing a television portal service, including: a messaging server module for: a) receiving a service request message frame through a message-based protocol transmitted from a client terminal via a network, parsing the received message frame and thereafter outputting the parsed service request message, and b) converting a service request and handling result message and a user informing message provided according to a request from the client terminal to the message frame through the message-based protocol, and thereafter transmitting the message frame to the client terminal via the network; and a message server for generating the relevant service request and handling message, and the user informing message according to the parsed service request message outputted from the messaging server module, and providing the messages for the messaging server module.

According to yet another embodiment of the present invention, there is provided a television portal services system, including: at least one or more service applications for performing a plurality of portal services based on a service message received via a network according to a user's request; a messaging client module for: a) converting a service request message generated from the plurality of service applications to a message frame format through a message-based protocol to transmit the message frame format via the network, and b) receiving the message frame format for the service message received via the network, parsing the received message frame format, and providing the parsed service message for a service application corresponding to the relevant service message of the plurality of service applications; a messaging server module for: a) parsing the service message frame through the message-based protocol received from the messaging client module via the network and thereafter outputting the parsed service request message, and b) converting a service request and handling result message and a user informing message provided according to a request from the messaging client module to a message frame through the message-based protocol, and thereafter transmitting the message frame to the messaging client module via the network; and a message server for generating the relevant service request and handling message, and the user informing message according to the parsed service request message outputted from the messaging server module, and providing the messages for the messaging server module.

The messaging client module of the client terminal may includes a message frame generating unit for generating the message frame corresponding to the service request message generated from the plurality of service applications to transmit the message frame to the messaging ls server module via the network; and a message parsing unit for parsing the service message frame transmitted from the messaging server module and providing the parsed service message for a service application corresponding to the relevant service, and may further include a message queue for temporarily storing the parsed service message from the messaging client module and then transferring the service message to an application corresponding to the relevant service.

The television portal services further comprises a FIFO (First In First Out) memory for temporarily storing the message so that the relevant message is displayed on a television screen through the relevant service application when the parsed message from the messaging client module is a message requiring a user's confirmation or an informing message to the user. The message may be displayed as an OSD (on-screen display) in a widget form in a case where a TV mode is a TV view mode, and in a message box or as an icon form using API (Application Program Interface) of OS (Operating System) in a case where the TV mode is a PC (Personal Computer) screen mode.

Further, the messaging server module of the server system may include: a message frame generating unit for generating a message frame corresponding to the service request and handling message, and the user informing message generated from the message server, and transmitting the generated message frame to the messaging client module via the network; and a message parsing unit for parsing the service message frame transmitted from the messaging client module and providing the parsed service message for the message server.

Moreover, according to the another embodiment of the present invention, there is provided, in a message-based protocol between a server terminal and a client terminal for providing a television portal service through the server and the client terminals, a message-based protocol between the server and the client terminals for providing a television portal service, which is capable of performing data transmission and reception between the server and the client terminals by producing a message type field for classifying properties of a message transmitted and received between the server and the client terminals; a service type field for classifying television portal service types; a data type field for classifying types of data transmitted and received between the server and the client terminals; a data field including actual data transmitted and received between the server and the client terminals; and a result type field for classifying message handling results, respectively, and by adding a relevant message to each produced field.

Meanwhile, according to another embodiment of the present invention, there is provided a method of processing a message in a client terminal to provide a television portal service, including the steps of: if service request messages are generated from a plurality of service applications according to a user's request, generating a message frame for at least one or more generated service request messages through a message-based protocol, and transmitting the generated message frame to a server via a network; receiving the message frame for response, handling and informing messages for a user request message received from the server via the network; and performing the relevant service by parsing the received message frame and by providing the parsed service message for a service application corresponding to the relevant service message of the plurality of service applications.

According to a further embodiment of the present invention, there is provided a method of processing a message in a server to provide a television portal service, including steps of: receiving a service request message frame through the message-based protocol transmitted from the client terminal via the network; parsing the received message frame to extract the service request message; producing a message frame for a response and handling result message to the service 1s request and a user informing message through a message-based protocol according to the extracted service request message; and transmitting the produced message frame to the client terminal via the network.

According to another embodiment of the present invention, there is provided a television portal services method, including steps of: if service request messages are generated from a plurality of service applications of a client terminal according to a user's request, generating a message frame for at least one or more generated service request messages through a message-based protocol, and transmitting the generated message frame to a server via a network; receiving the service request message frame through the message-based protocol transmitted from the client terminal via the network, and parsing the received message frame to extract the service request message; producing a message frame for a response and handling result message to the service request and a user informing message through a message-based protocol according to the extracted service request message, and then transmitting the message frame to the client terminal via the network; and performing the relevant service by parsing the message frame transmitted from the server via the network and by providing the parsed service message for a service application corresponding to the relevant service message of the plurality of service applications.

Here, formats of the message frame transmitted from the server and the message frame transmitted to the server have the same format structure through the same message-based protocol.

The formats of the message frame transmitted from the server and the message frame transmitted to the server include a message type field for classifying properties of a message transmitted and received between the server and the client terminal; a service type field for classifying television portal service types; a data type field for classifying types of data transmitted 15 and received between the server and the client terminal; a data field including actual data transmitted and received between the server and the client terminal; and a result type field for classifying message handling results.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a construction of an example TV portal services system;

FIG. 2 is a block diagram illustrating a construction of a TV portal services system according to the present invention;

FIG. 3 is a diagram illustrating a message frame format transmitted and received between a client and a server according to the present invention;

FIG. 4a is a diagram illustrating a data format for a message type as shown in FIG. 3; FIG. 4b is a diagram illustrating a data format for a service type as shown in FIG. 3;

FIG. 4c is a diagram illustrating an example of a data type included in a data type as shown in FIG. 3, and an actual transmission data format corresponding to the data type;

FIG. 4d is a diagram illustrating an example of a data format for classification of message handling result (result type) as shown in FIG. 3;

FIG. 5 is a diagram illustrating an operation flow upon a message receipt in the client according to the present invention;

FIG. 6 is a diagram illustrating an operation flow upon message transmission from the client to the server according to the present invention;

FIG. 7 is a diagram illustrating a log on/log off message flow between the client and the server according to an embodiment of the present invention;

FIG. 8 is a diagram illustrating a message flow for an informing service from the server to the client according to an embodiment of the present invention;

FIG. 9 is a diagram illustrating an order receipt message flow between the client and the server upon order service according to an embodiment of the present invention;

FIG. 10 is a diagram illustrating a post-order-receipt cancellation message flow between the client and the server upon order service according to an embodiment of the present invention;

FIG. 11 is a diagram illustrating a reservation receipt message flow between the client and the server upon reservation service according to an embodiment of the present invention;

FIG. 12 is a diagram illustrating a post-reservation-receipt cancellation message flow between the client and the server upon reservation service according to an embodiment of the present invention;

FIG. 13 is a diagram illustrating an EPG (electronic program guide) broadcast reservation message flow between the client and the server upon EPG service according to an embodiment of the present invention; and

FIG. 14 is a diagram illustrating a VOD (video-on-demand) service message flow between the client and the server upon VOD service according to an embodiment of the present invention.

### DESCRIPTION OF THE PREFERRED EMBODIMENTS

Hereinafter, a television portal services apparatus will be described with reference to the accompanying figures.

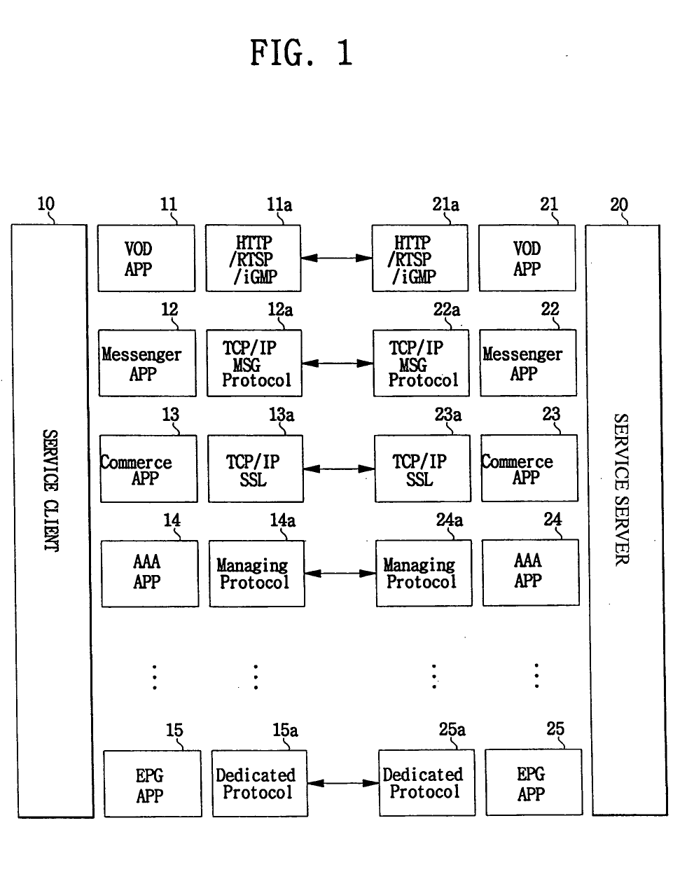

FIG. 1 is a block diagram illustrating a construction of an example television portal service apparatus.

As shown in FIG. 1, the television portal services apparatus consists of a service client 10 and a service server 20. The service client 10 and the service server 20 are provided with respective service applications 11 to 15 and 21 to 25, which perform relevant services according to respective service types.

Further, respective protocols 11a to 15a and 21a to 25a, which process data transmitted and received to perform respective services, are adopted between respective applications of the client 10 and the server 20. Here, home portal services include, for example, a VOD (Video-on-Demand) service, a messenger (MSG) service, an electronic commerce service, an AAA (Authentication, Authorization, Accounting) service . . . and an EPG (Electronic Program Guide) service.

An Internet portal service is an aggregate of a variety of techniques from a simple WEB-based service such as an additional service to a multimedia service such as VOD. Each service is managed and controlled by entirely different protocol stacks in properties. That is, the additional service is composed of WEB contents using HTML. A commerce service, a channel control, user authentication, and VOD adopt a security protocol, a CCP (Channel Change Protocol) such as DAVIC (Digital Audio-Visual Council), a managing protocol defined in the AAA server, and a stream control protocol such as RTSP (Real Time Streaming Protocol) and iGMP (Internet Group Management Protocol), respectively. Thus, each time one service is additionally implemented, a corresponding separate software stack must be constructed.

It is necessary to construct a protocol stack dependent on each service type in both the service client 10 and the service server 20 in order to perform each service. For example, the VOD service will use HTTP/RTSP/iGMP 11a and 21a. The messenger, electronic commerce, AAA, and EPG services will adopt TCP/IP MSG protocols 12a and 22a, TCP/IP SSL protocols 13a and 23a, managing protocols 14a and 24a, and dedicated protocols 15a and 25a, respectively.

A protocol for each service will be described in further detail.

First, in case of RTSP (Real Time Streaming Protocol) and DSM-CC (Digital Storage Media Command and Control) protocol used in the VOD service, services such as the VOD provided over the Internet operate in a client/server form configured by a side that provides information always and a side that uses the information.

RTSP is a protocol for transferring multimedia information with a relatively loose temporal constraint in a client/server environment using the Internet. A client requests video and audio information with a real time characteristic to a server, and in response to this request, the server transmits the information. In transmission, pause, stop, resume, close, etc., which are basic functions of a VCR (Video Cassette Recorder), are available. Streaming is a technique for allowing continuous reproduction while maintaining a real time characteristic to a certain extent by such a manner that, when the server fragments and transmits a compressed continuous message, a receiving side does not decode/reproduce the message after receiving all of the messages but decode the message each time the receiving side receives a certain unit of the message.

RTSP can simultaneously control a plurality of media information streams in unicast and multicast environment and operate in various transport layer protocols including TCP (transmission control protocol) and UDP (user datagram protocol), and uses RTP/RTCP (real-time transport protocol/real-time control protocol). In order to send a control message, the RTSP performs RTP/RTCP channel setting using the reliable TCP and then causes the RTP/RTCP packet to be sent. That is, setting and releasing a session are controlled by the RTSP while actual information is transferred through the RTP.

The VOD service using an ATM (asynchronous transfer mode) network uses the DSM-CC (Digital Storage Media Command and Control) protocol. The DSM-CC is a protocol in an application layer for operation and control functions on a MPEG-1/2 bit stream, and is being subjected to a standardization task in a subgroup of an MPEG (Motion Picture Experts Group) standardization group. The DSM-CC is a signal protocol for a set top, a video server and a communication network, and has a main purpose of controlling the MPEG bit stream transmitted from a video storage medium, which stores the MPEG data. For the sake of this, The DSM-CC was constructed in the MPEG standardization group in 1994 and has been adopted as an international standard on June 1996 after several draft writings.

A session management standard of a central concentration manner is made in the DSM-CC in order to control the MPEG bit stream. That is, SRM (Session & Resource Manager) manages a bandwidth for MPEG bit stream transmission with Q.2931 signaling proxy. Also, file access, directory control, and database control procedure as well as stream control are performed between the client and the server. DSM-CC describes a standard specification for MPEG bit stream control in stand-alone or heterogeneous network environment.

In addition, SSL (Secure Sockets Layer) protocol used in the electronic commerce service uses a manner of adding an intermediate step along with network connection setting, and of requesting security maintenance transmission options. In that connection state, data stream between the server and the client is encrypted prior to transmission, and the encrypted data stream is decrypted prior to utilization. An outgoing encrypted data is packaged by the TCP and then transferred to the Internet. An incoming encrypted data is received and thereafter is sent to an SSL layer for decryption.

This approach in the SSL protocol can apply SSL to any Internet application as well as WWW (World Wide Web). SSL was initially implemented under HTTP. Also, if SSL connection compromise is made between the server and the client, a resultant data communication channel becomes an individual, confirmation-acquired and reliable channel.

An initiation of SSL links is effected by a handshaking exchange between the server and the client. At this time, two systems exchange necessary encryption information, and support security channels. After the information exchange, an application program should be sent to a destination application program after being subjected to essential encryption needed for transmission. The destination application program performs an encryption necessary for data decryption and confirmation.

The SSL (Secure Sockets Layer) runs between an Internet application and a network transport layer, and encrypts the data communicated between the client and the server.

Meanwhile, as protocols used in the AAA service, TACACS (Terminal Access Controller Access Control System), RADIUS (Remote Access Dial-In User Service), and DIAMETER protocols can be used.

The TACACS is a little old authentication protocol applied to UNIX networks, allowing is a remote access server to send a user's log in password to an authentication server in order to determine whether to permit access to a given system. Since the TACACS is a non-encrypted protocol, it has poor stability as compared to subsequent TACACS+ and RADIUS protocols. A subsequent version of the TACACS is XTACACS (Extended TACACS), both of them being described in RFC (Network Working Group Request for Comments) 1492: “An Access Control Protocol, Sometimes Called TACACS”.

The TACACS+ is an entirely new protocol. Generally, in more recently configured or updated networks, the TACACS+ and RADIUS are substituted by previous protocols. The TACACS+ uses the TCP while the RADIUS uses the UDP.

Some managers recommend using the TACACS+ because the TCP is a more stable protocol. The RADIUS has both authentication and permission in one user profile, whereas the TACACS+ is divided into two tasks. TACACS and XTACACS still run in a number of old systems.

Recently, the most widely used AAA service is based on the RADIUS protocol. This is a protocol for a small-scale network device, which supports a few subscribers requiring server-based authentication, but is not suitable for the AAA service for communication businesses that have to 8 simultaneously support hundreds to thousands of users over various technique basis. In order to solve limitations and problems of the RADIUS protocol, present IETF (Internet Engineering Task Force) defines a diameter protocol. The diameter protocol provides various access networks and security application services, and performs authentication, authority, verification and billing processes for wired and wireless access subscribers and roaming subscribers over multiple networks.

As a result, comprehensive management for individual user terminals is raised as a critical technical problem to respective service providers. That is, a consistent access is needed over a television portal service to manage and control a service use right, use time and inter-service association.

When configuring a portal using an individual protocol stack, for a terminal, it is required to modify each service application and the relevant protocol stack in both an existing terminal and a server to provide a service as an individual application is added according to the service. Thus, there is a problem that it is difficult to cope with it flexibly even though service pool provided by PP (Preferences Profile) is configured.

Although this configuration maintains independence in individual service implementation, it fails to have unity in view of system configuration and to provide technical flexibility conforming to a variety of service combinations in service gateway implementation.

Hereinafter, a TV portal services system and a method according to preferred embodiments of the present invention will be described in detail with reference to the accompanying drawings.

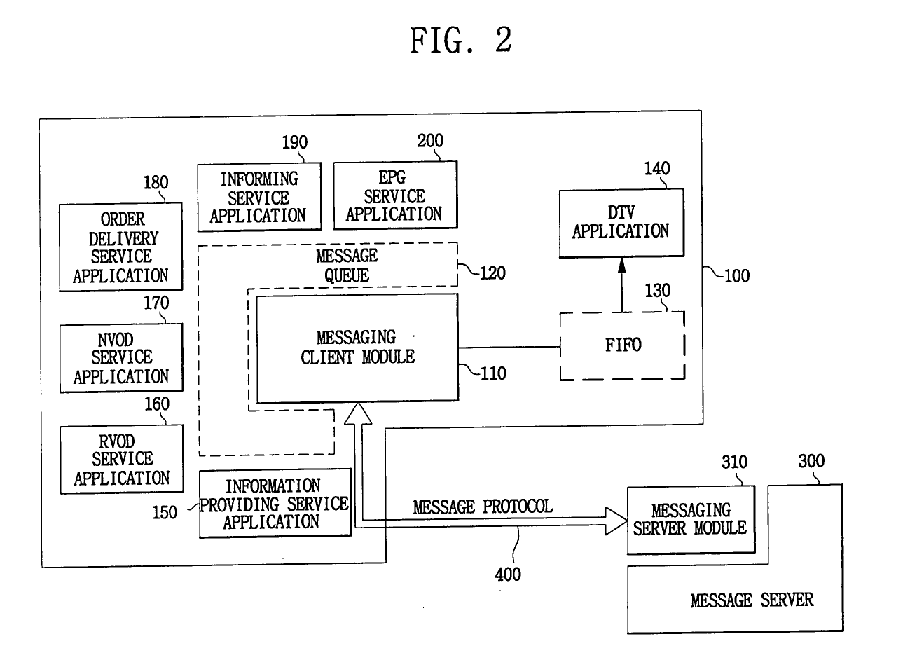

FIG. 2 is a block diagram illustrating a construction of a TV portal services system according to the present invention.

As shown in FIG. 2, the TV portal services system may be composed of a client terminal 100 and a server.

The server may be composed of a messaging server module 310 and a message server 300.

The client terminal 100 may be composed of a messaging client module 110, an optional message queue 120, an optional FIFO (First In First Out) 130, and a plurality of service applications 140-200 for respective services.

Here, the service applications for respective services may consist of, but are not limited to, a DTV application 140, an information providing service application 150, a RVOD (real video-on-demand) service application 160, a NVOD (near video-on-demand) service application 170, an order delivery service application 180, an informing service application 190 and an EPG (electronic program guide) service application 200.

A message protocol is operated in a server/client structure. The messaging server module 310 is disposed in the message server 300 and the messaging client module 110 is disposed in the client terminal 100. Here, the client terminal 100 may be a set top box or a gateway.

Messaging client module 110 is notified, using an IPC (Inter Process Communication), when a message to be transmitted to the sever is generated from any of the service applications 140-200.

In response thereto, the messaging client module 110 confirms the message generated by the service applications and received via the IPC, and thereafter, produces a message frame appropriate for each generated message.

The produced message frame is transmitted to the messaging server module 310 through a message protocol (socket) 400.

The messaging server module 310 parses the message frame transmitted from the client terminal 100 to check whether the message is requesting a service and thereafter to demand a corresponding service request to the message server 300.

The message server 300 provides the messaging server module 310 with a relevant service request and handling result message in response to the service request from the client terminal 100.

The messaging server module 310 parses the message provided from the message server 300 to produce a suitable message frame, and thereafter transmits the produced message frame to the messaging client module 110 in the client terminal 100 via the message protocol (socket) 400.

When receiving the message generated or responded from the server, the messaging client module 110 parses the message using a parser in the messaging client module 110 to transmit it to the relevant service application 140-200 via the IPC (Inter Process Communication).

Accordingly, the relevant service application receiving the message will perform the requested service.

In order that the service request and handling result message, which is transmitted from the server, is provided for each application via the messaging client module 110, the message queue 120 temporarily stores each message in a message structure for each message type by the messaging client module 110 and then provides the stored messages corresponding to respective ones of the applications, via the API (Application Program Interface), to the relevant service application 140-200.

Also, when a message exists requiring a user's confirmation, such as in the informing service, among the messages transmitted from the server, FIFO 130 temporarily stores the relevant message so that it is displayed on a DTV screen (not shown) via the DTV application 140. Here, a message display method includes the following: in the TV view mode, the message is displayed as an OSD (on-screen display) in a widget form, and in the PC screen mode the message is displayed in a message box or as an icon form using the API (Application Program Interface) of the OS (operating system).

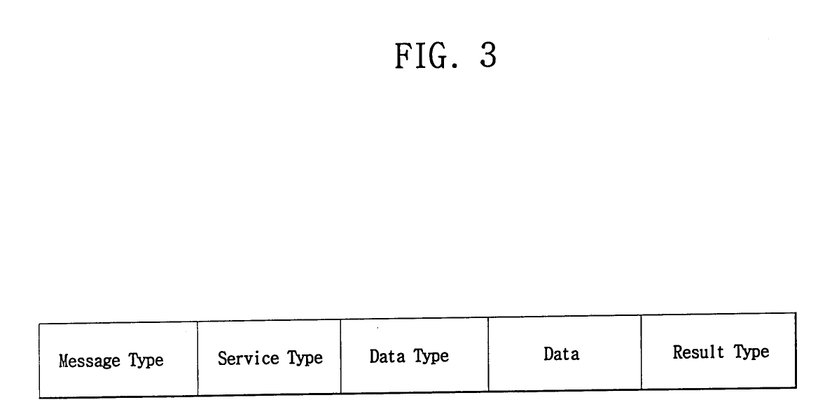

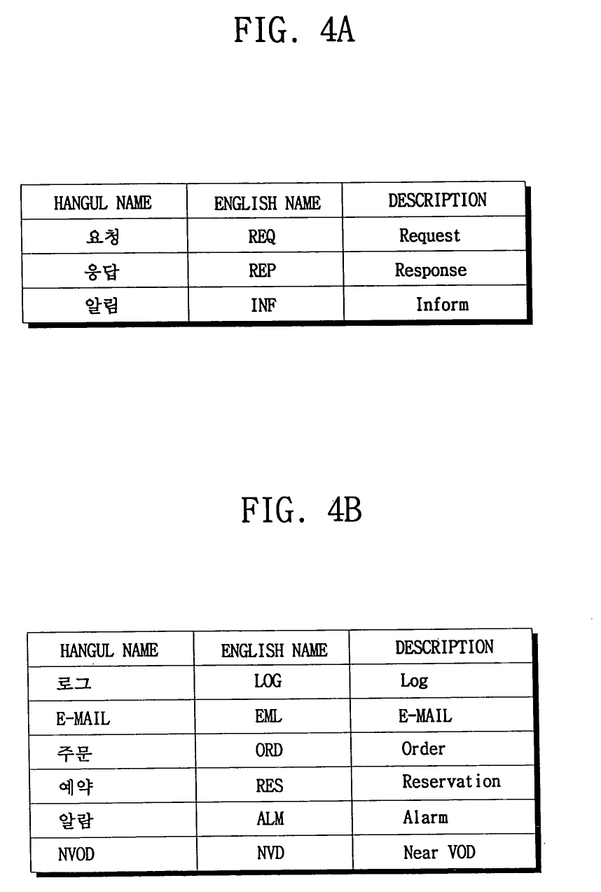

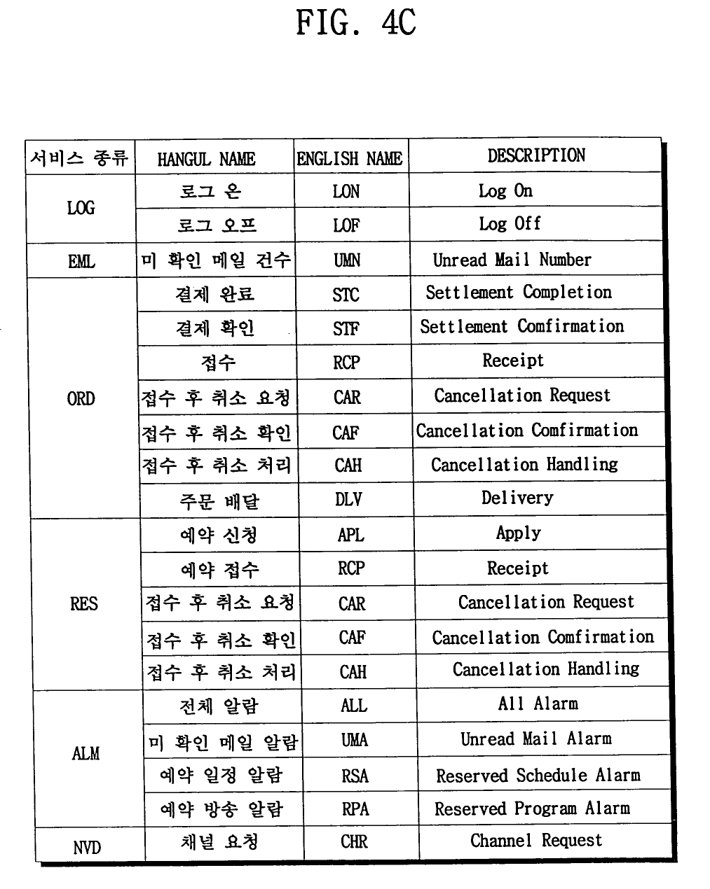

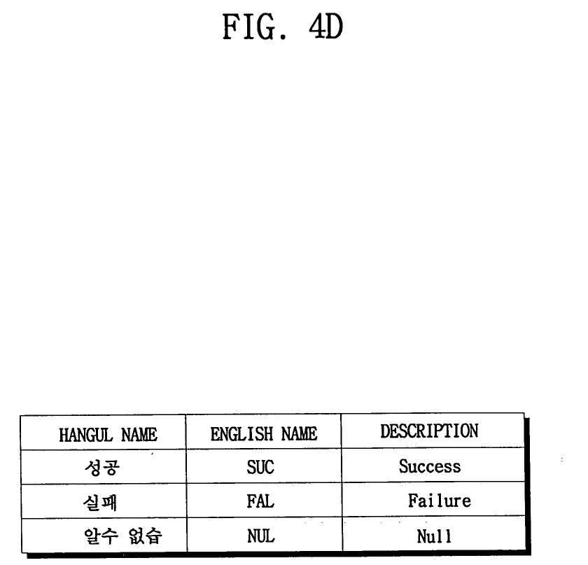

The format structure of the message frame transmitted and received between the server and the client will be described in detail with reference to the accompanying FIGS. 3 and 4a to 4d.

FIG. 3 is a diagram illustrating a message frame format transmitted and received between the client and the server according to the present invention, FIG. 4a is a diagram illustrating a data format of a message type as shown in FIG. 3, FIG. 4b is a diagram illustrating a data format of a service type as shown in FIG. 3, FIG. 4c illustrates an example of a data type included in a data type as shown in FIG. 3 and an actual transmission data format corresponding to the data type, and FIG. 4d illustrates an example of a data format for classification of a message handling result (result type) as shown in FIG. 3.

As shown in FIG. 3, the message frame format transmitted and received between the client and the server is classified into a message type field for classifying message properties, a service type field for classifying service types, a data type field for classifying data types, and a result type field for classifying actual data and message handling result to be transmitted.

Here, the message type information, as shown in FIG. 4a, can be classified into a request (REQ) type message, a response (REP) type message and an informing (INF) type message.

The service type information, as shown in FIG. 4b, can be classified, for example, into a log in/out service (LOG), an E-MAIL service (EML), an order service (ORD), a reservation service (RES), an alarm service (ALM) and an NVOD service (NVD). It should be apparent that there are a number of other possible services not listed here for the sake of brevity.

In addition, as the data type and data for the service types, as shown in FIG. 4c, the LOG service includes log on (LON) data and log off (LOF) data as the data type and the EML service includes unread mail number (UMN) data as the data type.

The data included in the ORD service can be classified into settlement completion (STC), settlement confirmation (STF), receipt (RCP), post-receipt cancellation request (CAR), post-receipt cancellation confirmation (CAF), post-receipt cancellation handling (CAH) and order delivery (DLV) data.

The data included in the RES service can be classified into reservation applying (APL), reservation receipt (RCP), post-receipt cancellation request (CAR), post-receipt cancellation confirmation (CAF) and post-receipt cancellation handling (CAH) data.

And, the data included in the ALM service is classified into all alarm (ALL), unread mail alarm (UMA), reserved schedule alarm (RSA) and reserved program alarm (RPA) data.

Meanwhile, the NVD service includes channel request (CHR) data.

As shown in FIG. 4d, the result type information is classified into success (SUC), failure (FAL) and unknown information (NUL).

As a result, the data transport frame format between the client and the server is transmitted in a message frame form through a message-based protocol as shown in FIG. 3, including each information as shown in FIGS. 4a to 4d. That is, the message frame transmitted and received includes message type, service type, data type, data, and result type information.

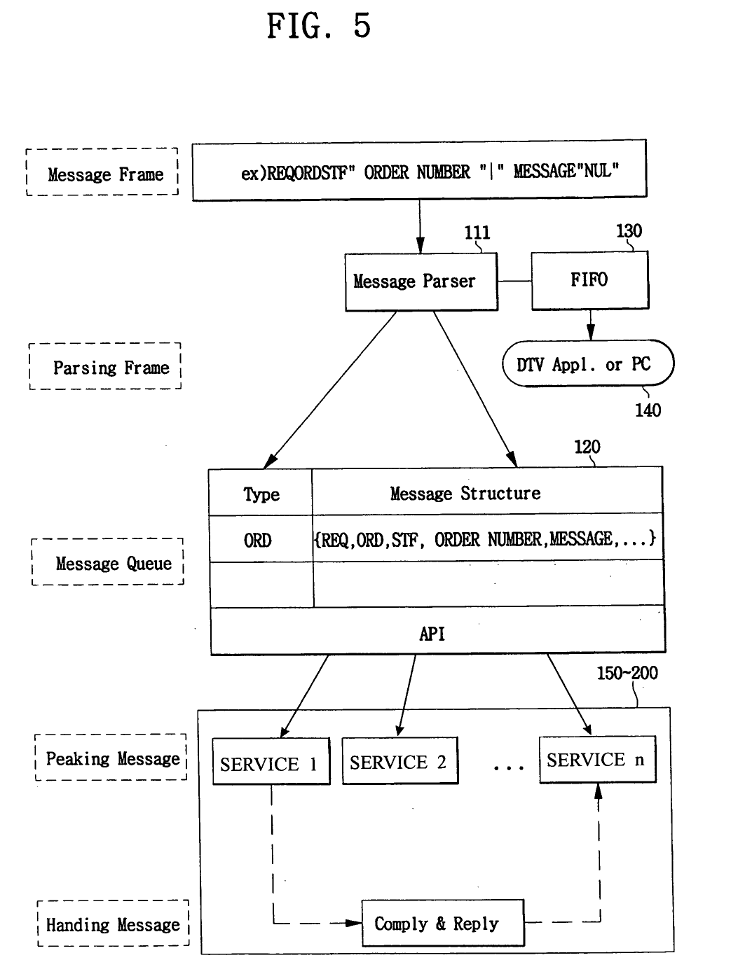

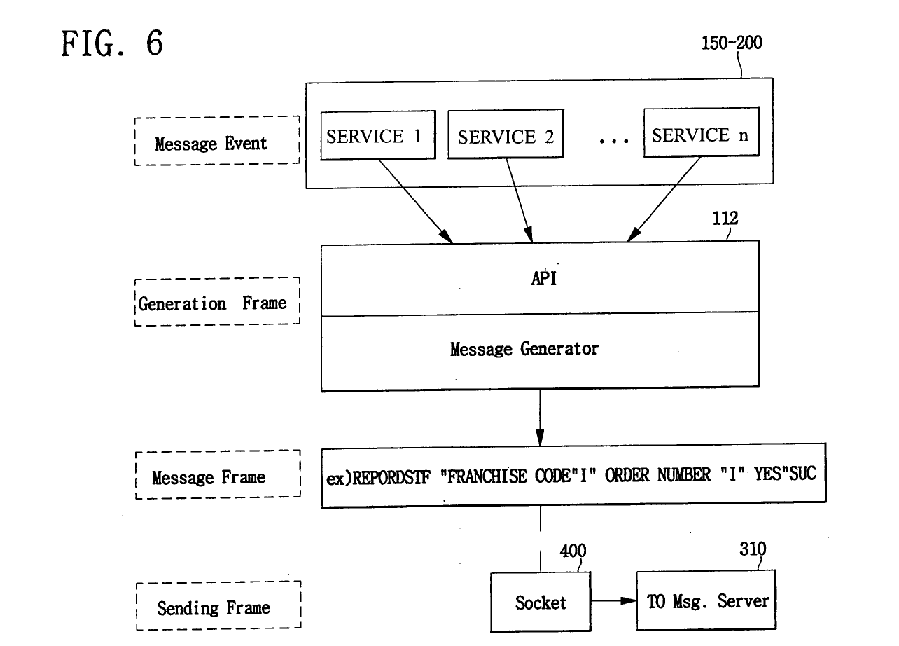

An operation of transmitting and receiving a message between the client and the server using such a message frame format will be described with reference to the accompanying FIGS. 5 and 6.

FIG. 5 is a diagram illustrating an operation flow upon a message receipt in the client according to the present invention, and FIG. 6 is a diagram illustrating an operation flow upon a message transmission from the client to the server according to the present invention.

First, an operation in which the client receives the message transmitted from the server will be described with reference to FIG. 5.

As shown in FIG. 5, if each client terminal 100 connected to the network is powered on, it attempts a connection to the message server 300 via a predefined dedicated port. When the connection is not established, the client terminal again attempts the connection at several second intervals. When the connection is established between the client terminal 100 and the message server 300, the client terminal performs a “log in” using a unique ID of the client terminal 100 and a dynamic IP number allocated from a DHCP (Dynamic Host Configuration Protocol) server. If an authentication is completed, the established connection is continuously maintained as long as no exception situations (for example, abnormality in the network or the server, etc.) are arisen.

If a message frame (e.g., REQORDSTF“order number”|“message”NUL: a response message to an order settlement confirmation request) is received, which is transmitted from the message server 300 via the messaging module 310, a message parser 111 in the messaging client module 110 parses the received message, stores it in the message queue 120 temporarily, and then transfers it to the relevant service applications 150 to 200 via the IPC. Accordingly, the relevant application, which has received the message, will perform the relevant service.

At this time, if the received message type needs the user's confirmation request, the relevant request message is temporarily stored in the FIFO 130, and thereafter displayed on a console, which is connected to the client terminal 100, in which in the TV view mode, the message is displayed on the OSD in a widget form, while in the PC screen mode, it is displayed in a message box or an icon form using the API of the OS. That is, the relevant confirmation message is displayed through the DTV application or the PC application 140.

Meanwhile, the following message transmission from the client terminal 100 to the message server 300 is performed. That is, as shown in FIG. 6, if a message to be transmitted to the message server 300 is generated from any of arbitrary service applications 150-200 in the client terminal 100 according to a request from the user, this message generation is notified to the messaging client module 110 using the IPC.

The messaging client module 110 produces, in an internal message generator 112, a message frame (e.g., REPORDSTF“franchise code”|“order number”|−YES”SUC) for the message generated in the service applications 150 to 200, and transmits the produced message frame to the messaging server module 310 in the server through the message protocol (socket) 400.

Thus, when receiving the message frame from the client terminal 100, the messaging server module 310 parses the received message frame and provides the parsed message frame to the message server 300, such that a response or confirmation message to the message requested by the client terminal 100 is produced. The produced message is transmitted to the client terminal 100 through a message transmission flow as shown in FIG. 5.

Hereinafter, a message transmitting and receiving method between the client terminal 100 and the server 300 according to each service type will be described in steps with reference to the accompanying drawing.

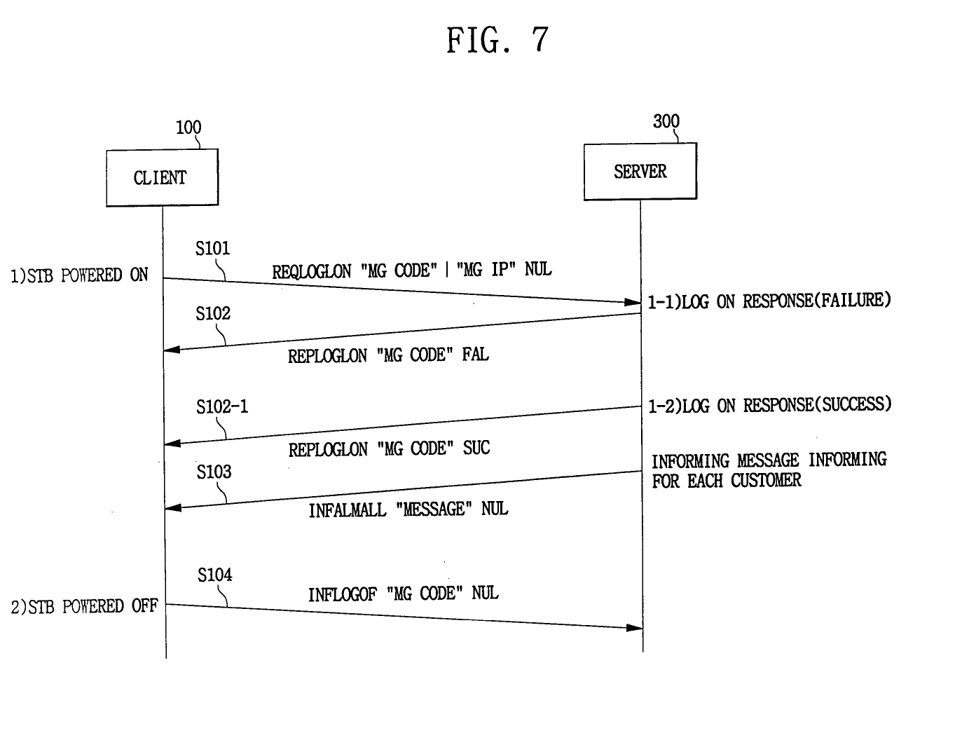

FIG. 7 is a diagram illustrating a log on/log off message flow between the client and the server according to an embodiment of the present invention.

First, when the client terminal 100, e.g., a set top box is powered on, the messaging client module 110 of the client terminal 100 produces a message frame for log in to the server, and then transmits the produced log in message frame (e.g., REQLOGON“MG code”|“MG IP”NUL) to the message server 300 via the message protocol (S101).

After parsing the log in message frame transmitted from the client terminal 100 to perform authentication of the relevant client terminal 100, the message server 300 produces a log on response message frame in the messaging server module 310 according to an authentication result to transmit the produced response message frame to the messaging client module 110 via the message protocol (socket) 400.

That is, if the authentication and thus the log on of the relevant client terminal 100 is failed, the message server produces a log on failure response message frame (e.g., REPLOGON“MG code”FAL) to transmit it to the messaging client module 110 of the client terminal 100 (S102), while, if the authentication and thus log on of the relevant client terminal 100 is successful, the message server produces the log on success response message frame (e.g., REPLOGON“MG code”SUC) to transmit it to the messaging client module 110 of client terminal 100 (S102-1).

Thus, if the log on of the client terminal 100 is successful, the message server 300 confirms whether any informing information for the relevant client terminal 100 exists or not. If the informing information exists, the message server produces, in the messaging server module 310 of the message server 300, an informing message frame (e.g., INFALMALL“message”NUL) for each customer to transmit it to the messaging client module 110 of the client terminal 100 via the message protocol 400 (S103).

Thus, the messaging client module 110 of the client terminal 100 parses the informing message frame transmitted from the server, and provides the parsed relevant informing message for an informing service application 190 so that the relevant informing service is performed.

In the operation, when the user powers off the client terminal 100, the messaging client module 110 produces a message frame (e.g., INFLOGLOF“MG code”NUL) for the power-off to transmit it to the messaging server module 310 of the message server 300 (S104).

If the messaging server module 310 parses the log off message frame transmitted from the messaging client module 110, and thereafter transfers the parsed log off message to the message server 300, the message server 300 deletes the ID of the relevant client terminal 100 from a client connection list, which is managed by the message server 300.

As a result, the following log on/log off service as shown in FIG. 7 is performed. That is, when the client terminal 100 is powered on, the messaging client module 100 attempts the connection to the server, and if the connection is established, the log on procedure is performed by using the unique ID of the client terminal 100 in order to notify to the server whether various portal services are available or not.

However, if the client terminal 100 is powered off, the messaging client module 100 sends the log off message to the server in order to request to delete the ID of the relevant client terminal 100 from a connection list managed by the server.

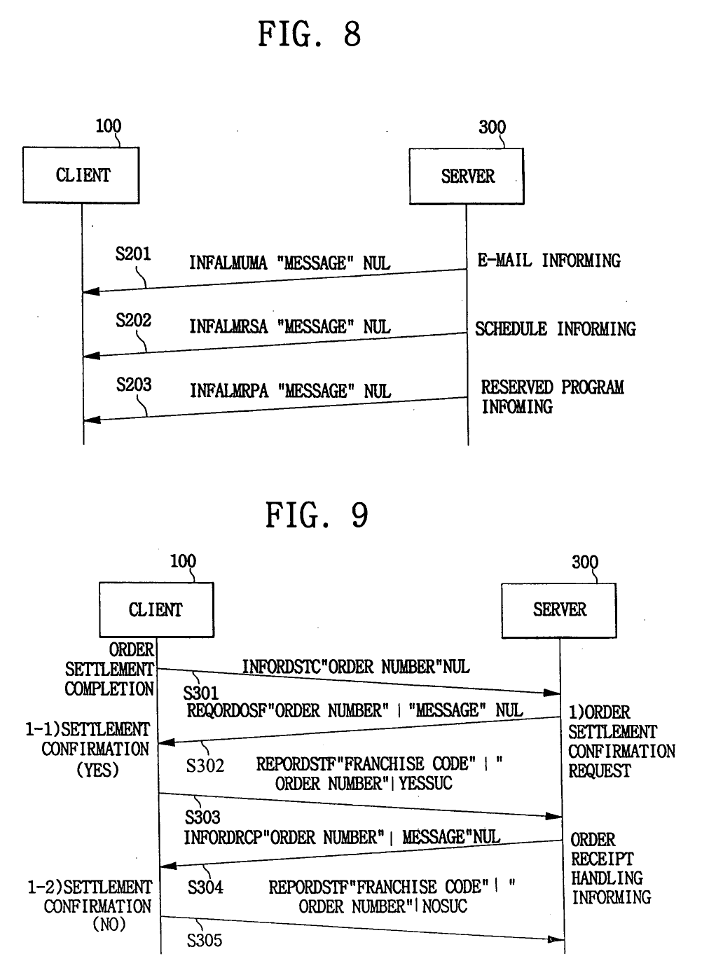

FIG. 8 is a diagram illustrating a message flow for an informing service from the server to the client according to an embodiment of the present invention.

As shown in FIG. 8, when any informing situation from the server 300 to the client terminal 100 exists. For example, when an e-mail informing, reserved schedule informing, or reserved program informing situation is generated, the message server 300 notifies the messaging server module 310.

The messaging server module 310 then produces a message frame, such as an INFALMUMA“message”NUL message frame in case of the e-mail informing, an INFALMRSA“message”NUL message frame in case of the reserved schedule informing, or an INFALMRPA“message”NUL message frame in case of the reserved program informing, for the informing message generated from the message server 300, and transmits it to the messaging client module 110 of the client terminal 100 through the message protocol 400 (S201, S202, S203, respectively).

The messaging client module 110 of the client terminal 100 parses the informing message frame transmitted from the server, stores each informing message temporarily in the message queue 120, and thereafter transfers the informing message to the informing service application 190 so that the informing service is performed. Alternatively, when the user's confirmation is needed, the client module temporarily stores the informing message in the FIFO 130 and thereafter transfers the informing message sequentially to the DTV application 140 so that the informing message is displayed on the DTV screen. At this time, as described above, in the TV view mode the message is displayed on the OSD in a widget form, and in the PC screen mode it is displayed using the API of the OS in a message box or an icon form. This informing service may be used along with the EPG, order delivery, or E-MAIL service.

FIG. 9 is a diagram illustrating an order receipt message flow between the client and the server upon order service according to an embodiment of the present invention.

As shown in FIG. 9, if a message for a product order is generated from the order delivery service application 180 of the client terminal 100, the messaging client module 110 of the client terminal 100 produces the message frame for the order message and transmits it to the messaging server module 310 in the server via the message protocol 400.

The messaging server module 310 parses the order message frame transmitted from the client terminal 100 and then transfers the order message to the message server 300. Then, the message server 300 transmits an order request message to the franchise to which a relevant product is ordered according to the product order message.

A franchise terminal (not shown) handles the order according to the order message transmitted from the server, and thereafter provides an order handling result information to the server. The server provides the order handling result message to the client terminal 100.

At this time, if an order settlement completion message from the order delivery service application 180 in the client terminal 100 for the product order is produced, the messaging client module 110 of the client terminal 100 produces a message frame (e.g., INFORDSTC“order number”NUL) for the order settlement completion message and transmits it to the messaging server module 310 via the message protocol 400 (S301).

The messaging server module 310 parses the message frame transmitted from the messaging client module 110 in the client terminal 100 and transfers the order settlement completion message to the message server 300.

The message server 300 transfers an order settlement confirmation request message (OSF) to the messaging server module 310 according to the order completion message transferred from the messaging server module 310.

The messaging server module 310 produces a message frame (REQORDOSF“order number”|“message”NUL) for the order settlement confirmation request message transferred from the message server 300 to transmit it to the messaging client module 110 of the client terminal 100 (S302).

The messaging client module 110 parses the order settlement confirmation request message frame transmitted from the server and temporarily stores the order settlement confirmation request message in the message queue to transfer it to the order delivery service application 180.

Further, the messaging client module 110 parses the received message frame, and, because the relevant message is a message requiring the user's confirmation, transfers it to the DTV application 140 via the FIFO so that it is displayed on the DTV.

If the user completes the settlement confirmation (YES) in response to the displayed settlement confirmation message, the messaging client module 110 produces a message frame (REPORDSTF“franchise code”|“order number”|“YESSUC) for the settlement confirmation message to transmit it to the messaging server module 310 in the server (S303).

After parsing the received settlement confirmation message frame, the messaging server module 310 transfers the settlement confirmation message to the message server 300. The message server 300 transmits the settlement confirmation message to the relevant franchise so that the order is handled.

After handling the order, the franchise terminal transmits an order handling result message (Receipt) to the message server 300. The message server 300 produces the order handling informing message according to the order handling result message transmitted from the franchise and transfers it to the messaging server module 310.

The messaging server module 310 produces a message frame (INFORDRCP“order number”|“message”NUL) for the order handling informing message transferred from message server 300 and transmits it to the messaging client module 110 of the client terminal 100 (S304).

Thus, after parsing the relevant frame and storing the parsed order handling informing message in the message queue, the messaging client module 110 transfers it to the order delivery service application 180 so that the relevant service is performed, and at the same time, to the DTV application 140 so that the order handling result message is displayed on the DTV, which allows the user to confirm the order handling result.

However, in S302, if the user selects the settlement confirmation (NO) after receiving a ls message frame (REQORDOSF“order number”|“message”NUL) for the order settlement confirmation request message transmitted from the server, the messaging client module 110 produces a frame REPORDSTF“franchise code”|“order number”|“NOSUC) for the order settlement confirmation (NO) message to transmit it to the server. Thus, the server transmits the settlement confirmation (NO) message to the franchise so that the order cancellation operation is performed.

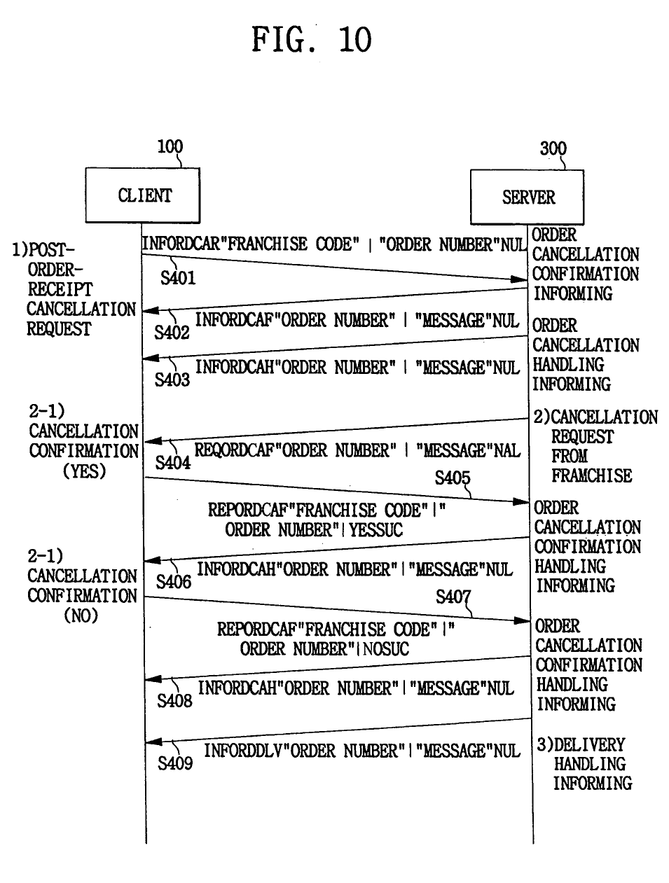

The post-order-receipt cancellation service will be described with reference to FIG. 10.

FIG. 10 is a diagram illustrating a post-order-receipt cancellation message flow between the client and the server upon order service according to an embodiment of the present invention.

As shown in FIG. 10, first, if a cancellation request message is generated from the order delivery service application 180, the messaging client module 110 produces a message frame (INFORDCAR“franchise code”|“order number”NUL) for the cancellation request message, and transmits it to the messaging server module 310 in the server (S401).

The messaging server module 310 in the server parses the message frame transmitted from the client terminal 100 and transfers the cancellation request message to the message server 300, which is then sent to a franchise terminal.

If the message server 300 receives a post-order-receipt cancellation confirmation message from the franchise terminal after transmitting the cancellation request message received from the client terminal 100, to the relevant franchise terminal, it generates an order cancellation confirmation informing message, produces a message frame (INFORDCAF“order number”|“message”NUL) for the generated order cancellation confirmation informing message in the messaging server module 310, and transmits it to the messaging client module 110 of the client terminal 100 (S402).

Furthermore, if the message server 300 receives an order cancellation handling message from the franchise terminal, it generates an order cancellation informing message to transfer the relevant message to the messaging server module 310.

The messaging server module 310 produces a message frame (INFORDCAH“order number”|“message”NUL) for the order cancellation handling message to transmit it to the messaging client module 110 of the client terminal 100 (S404). The messaging client module 110 parses the received message frame, transfers the order cancellation handling message to the order delivery service application 180 to handle the relevant service, and transfers the relevant message to the DTV application 140 so that the relevant message is displayed, which enables the user to confirm the order cancellation result.

The foregoing is a message flow in case where the post-order-receipt cancellation request from the user exists. Hereinafter, a case will be described in which the order cancellation request from a franchise exists.

First, if an order cancellation request from the franchise terminal exists, the message server 300 produces an informing message for the order cancellation request transmitted from the franchise terminal and transfers the relevant message to the messaging server module 310.

The messaging server module 310 produces a message frame (REQORDCAF“order number”|“message”NUL) for the franchise order cancellation informing message generated from the message server 300 to transmit it to the messaging client module 110 of the client terminal 100 (S404).

The messaging client module 110 parses the message frame transmitted from the messaging server module 310 and transfers the order cancellation informing message to the order delivery service application 180 to perform the relevant service. In addition, the messaging client is module 110 transfers the relevant message to the DTV application 140 so that the relevant message is displayed, which enables the user to effect an order cancellation confirmation response.

If the user selects the order cancellation confirmation response message “YES”, the messaging client module 110 produces a message frame (REPORDCAF“franchise code”|“order number”YESSUC) for the order cancellation confirmation response message to transmit it to the messaging server module 310 (S405).

The messaging server module 310 parses the message frame transmitted from the messaging client module 110 and transmits the relevant message, i.e., the order cancellation confirmation response message, to the franchise terminal so that the order cancellation is handled. If the order cancellation is completed, the franchise terminal transmits the order cancellation handling result message to the server.

In response thereto, the messaging server module 310 in the server produces a frame (INFORDCAH“order number”|“message”NUL) for the order cancellation confirmation handling informing message to transmit it to the messaging client module 10 (S406).

Meanwhile, in the step S404, if the user selects cancellation confirmation “NO” when the client receives the order cancellation request message as the order cancellation request message is received from the franchise, an operation of transmitting and receiving the order cancellation response message (S407, S408) is performed in the same method as the above-stated operation. Therefore, detailed explanation on the operation will be omitted.

Also, if the message from a franchise is received, which indicates that the order delivery handling of the product is completed, the messaging server module 310 transmits a message frame (INFORDDLV“order number”|“message”NUL) for the delivery handling informing message to the messaging client module 110 in order to complete the order delivery service operation.

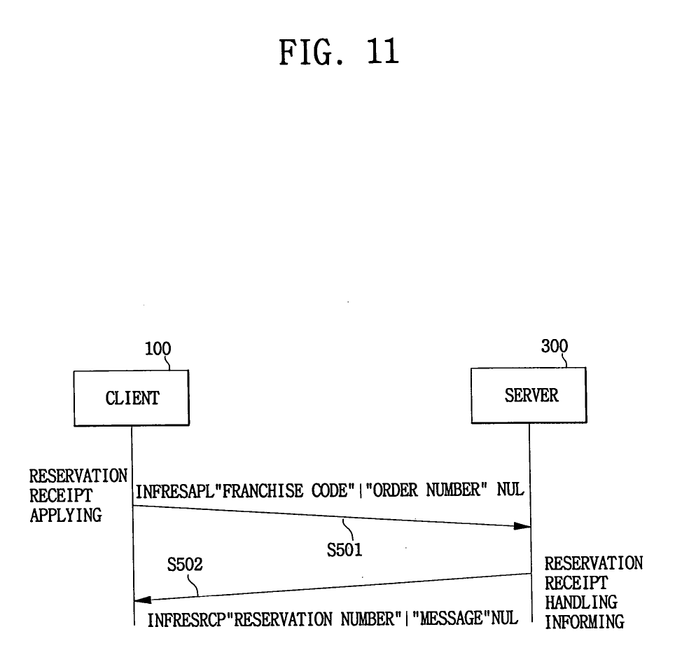

FIG. 11 is a diagram illustrating a reservation receipt message flow between the client and the server upon reservation service according to an embodiment of the present invention.

As shown in FIG. 11, if an order reservation receipt application from user exists, the order delivery service application 180 generates an order reservation receipt application message.

The thus generated order reservation receipt application message is transferred to the messaging client module 110, the messaging client module 110 produces a message frame “INFRESAPL“franchise code”|”reservation number”NUL” for the generated order reservation receipt application message to transmit it the message server module 310 (S501).

The message server module 310 parses the message frame for the order reservation receipt application message transmitted from the client and transmits the relevant order reservation receipt application message to the relevant franchise.

The franchise performs an order reservation receipt according to the order reservation receipt application message transmitted from the server, and transmits an order reservation receipt handling result message to the messaging server module 310 in the server.

The messaging server module 310 in the server transmits, to the messaging client module 110 in the client, a message frame “INFRESRCP“reservation number”|“message”NUL for the reservation receipt handling informing message according to the order reservation receipt handling message transmitted from franchise (S502).

The messaging client module 110 parses the message frame for the reservation receipt handling informing message transmitted from the server, transfers the relevant message to the order delivery service application 180 to perform the relevant service, and transfers the relevant message to the DTV application 140 to display the order reservation handling informing message so that the user easily confirms the order reservation handling result.

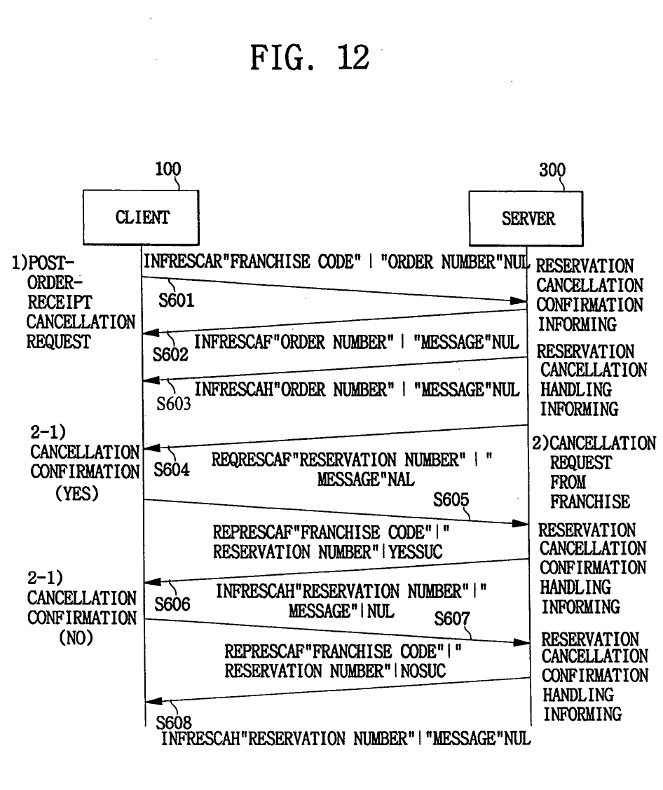

A case will be described with reference to FIG. 12, in which a reservation receipt, after an order reservation receipt, is cancelled.

FIG. 12 is a diagram illustrating a post-reservation-receipt cancellation message flow between the client and the server upon reservation service according to an embodiment of the present invention.

First, if the post-reservation-receipt cancellation request message is generated through the order delivery service application 180, the messaging client module 110 produces a message frame “INFORDCAR“franchise code”|“reservation number”NUL” for the post-reservation-receipt cancellation request message and transmits it to the messaging server module 310 in the server (S601).

The messaging server module 310 in the server parses the message frame transmitted from the client terminal 100 and transfers post-reservation-receipt cancellation request message to the relevant franchise terminal via the message server 300.

After transmitting the post-reservation-receipt cancellation request message received from the client terminal 100 to the relevant franchise terminal, if a post-reservation-receipt cancellation confirmation message is received from the franchise terminal, the message server 300 generates a reservation cancellation confirmation informing message, and in the messaging server module 310, produces a message frame INFORDCAF“reservation number”|“message”NUL” for the generated reservation cancellation confirmation informing message to transmit it to the messaging client module 110 of the client terminal 100 (S602).

Furthermore, if the message server (300) receives a reservation cancellation handling message from the franchise terminal, it generates the reservation cancellation handling informing message to transfer the relevant message to the messaging server module 310.

The messaging server module 310 produces a message frame “INFORDCAH“reservation number”|“message”NUL for the reservation cancellation handling informing message to transmit it to the messaging client module 110 of the client terminal 100 (S603).

The message client module 110 parses the received message frame, transfers the reservation cancellation handling informing message to the order delivery service application 180 to handle the relevant service, and transfers the relevant message to the digital television (DTV) application 140 to display the relevant message so that the user confirms the reservation cancellation result.

The foregoing is a message flow when a post-reservation-receipt cancellation request from a user exists. A case will be described in which the reservation receipt cancellation request from the franchise exists.

First, if the reservation cancellation request from the franchise terminal exists, the message server 300 produces an informing message for the reservation cancellation request transmitted from the franchise terminal to transfer the relevant message to the messaging server module 310.

The messaging server module 310 produces a message frame (REQORDCAF“reservation number”|“message”NUL) for a franchise reservation cancellation informing message generated from the message server 300 to transmit it to the messaging client module 110 of the client terminal 100 (S604).

The messaging client module 110 parses the message frame transmitted from the messaging server module 310, and transfers the reservation cancellation informing message to the order delivery service application 180 to perform the relevant service. Also, it transfers the relevant message to the DTV application 140 to display the relevant message so that the user performs a reservation cancellation confirmation response.

If the user selects a reservation cancellation confirmation response message “YES”, the messaging client module 110 produces a message frame (REPORDCAF“franchise code”|“reservation number”YESSUC) for the reservation cancellation confirmation response message and transmits it to the messaging server module 310 (S605).

The messaging server module 310 parses the message frame transmitted from the messaging client module 110 and transmits the relevant message, i.e., the reservation cancellation confirmation response message to the franchise terminal so that the reservation cancellation is handled. If the reservation cancellation is completed, the franchise terminal transmits a reservation cancellation handling result message to the server.

Then, the messaging server module 310 in the server produces a frame (INFORDCAH“reservation number”|“message”NUL) for the reservation cancellation confirmation handling informing message to transmit it to the messaging client module 110 (S606).

Meanwhile, in the step S604, if the user selects a cancellation confirmation “NO” when the reservation cancellation request message from the franchise is received and accordingly the order cancellation request message is received by the client, transmitting and receiving operations of the order cancellation response message (S607, S608) are performed in the same method as in the above-stated operation. Thus, explanation on detailed operation therefor will be omitted.

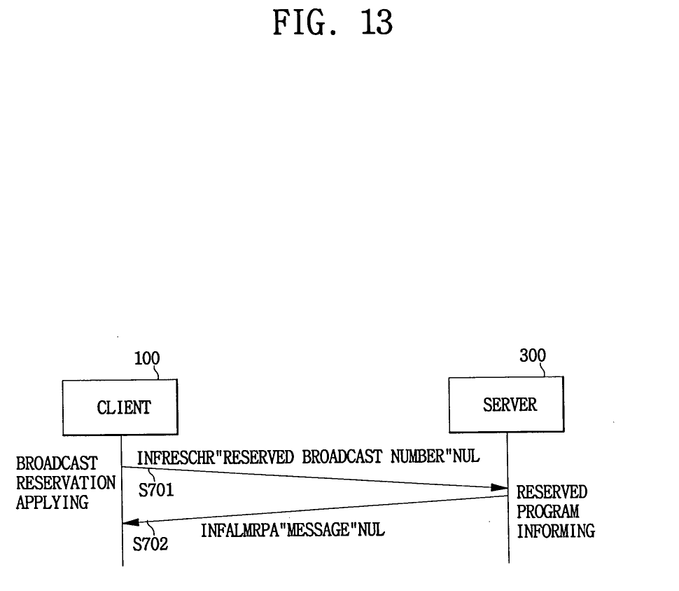

Hereinafter, a message flow upon the EPG broadcast reservation will be described with reference to FIG. 13.

FIG. 13 is a diagram illustrating an EPG broadcast reservation message flow between the client and the server upon EPG service according to an embodiment of the present invention.

As shown in FIG. 13, if the user effects a broadcast reservation application from an EPG service application 200 via an EPG screen, the messaging client module 110 of the client terminal 100 produces a message frame “INFRESCHR“reserved broadcast number”NUL” for the broadcast reservation message generated through the EPG service application 200 to transmit it to the messaging server module 310 in the server (S701).

The messaging server module 310 parses the message frame transmitted from the messaging client module 110 of the client terminal 100 to transfer the parsed message to the message server 300.

The message server 300 performs a broadcast reservation for a channel requested by the user using the broadcast reservation message transmitted from the messaging server module 310.

Further, the message server 300 checks a broadcast reservation time of the broadcast reserved program selected by the user and, if the relevant time is reached, the message server 300 produces a reserved program informing message to transfer it to the messaging server module 310.

The messaging server module 310 produces a message frame INFALMRPA“message”NUL for the reserved program informing message from the message server 300 and transmits the produced message frame to the messaging client module 110 (S702).

The messaging client module 110 parses the message frame for the broadcast reserved program informing message transmitted from the messaging server module 310 in the server to transmit the relevant message to the EPG service application 200 so that the relevant service, i.e., a function such as a channel changeover to a channel where the reserved program is broadcast, is performed, and also to transfer the relevant service to the DTV application 140 and display the reserved program informing message, which allows the user to confirm the message.

That is, the EPG service is provided on a basis of the web, allowing the broadcast reservation associated with the informing service. If a broadcast to be reserved is selected on an EPG screen reservation, it is transmitted to the server in conformity with a reservation message format.

If the relevant time reaches after recording a broadcast reservation situation, the server informs the terminal of it via the informing service. When receiving the reservation informing message, the terminal attempts an automatic channel switchover to the relevant channel or notifies it to the DTV application 140.

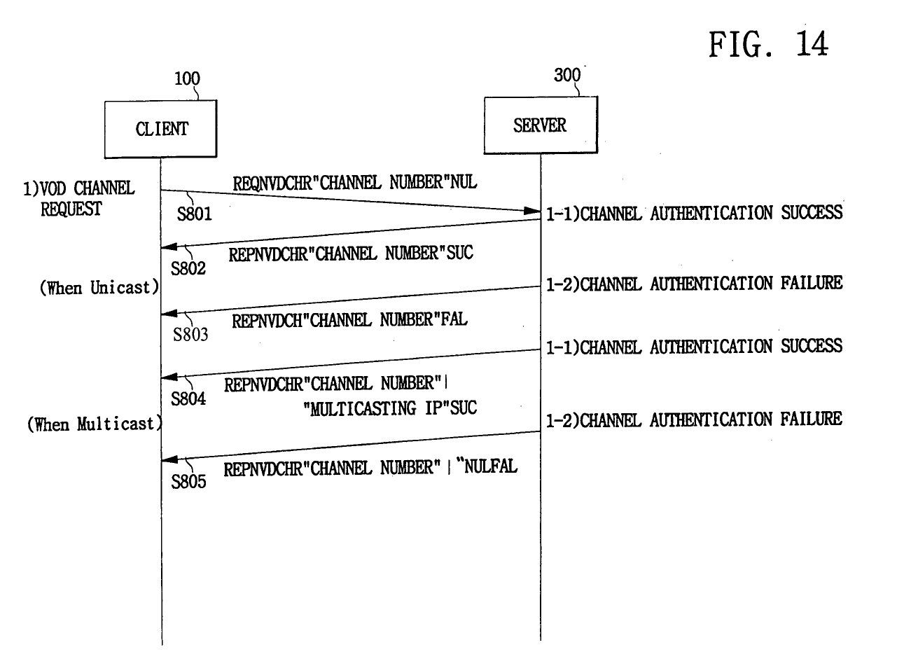

An operation of the VOD service via the message protocol will be described with reference to the accompanying FIG. 14.

First, if the user requests a VOD channel for viewing via the VOD service applications 160 and 170, the messaging client module 110 produces a message frame (REQNVDCHR“channel number”NUL”) for the VOD channel request to transmit it to the messaging server module 310 (S801).

The messaging server module 310 parses the message frame for the VOD channel request transmitted from the messaging client module 110 and transfers the VOD channel request message to the message server 300.

The message server 300 performs, using the VOD channel request message transferred from the messaging server module 310, channel authentication whether the relevant channel is a 15 channel available in the client terminal 100 or not.

If the channel authentication is successful or failed, that is, if the relevant channel is available in the client terminal 100 or not, the message server transmits the message frame for a channel authentication response message to the client terminal 100. If the relevant VOD service is unicast and if the authentication of the relevant channel is successful, the messaging server module 310 transmits an REPNVDCHR“channel number”SUC message frame and, adversely, if the VOD channel authentication is failed, the messaging server module 310 transmits an REPNVDCHR“channel number”FAL message frame to the messaging client module 110 of the client terminal 100 (S802, S803).

The messaging client module 110 parses, in the parser, the frame for the response message transmitted from the server, and transfers the relevant message to the VOD service application to display it so that the user confirms the message.

However, in case that the VOD service is multicast, if the channel authentication is successful with the response message frame to a VOD channel request, the message server transmits an REPNVDCHR“channel number”|”multicasting IP”SUC message frame to the messaging client module 110 of the client terminal 100 (S804). If the channel authentication is failed, the message server transmits an REPNVDCHR“channel number”|“NULFAL frame to the messaging client module 110 of the client terminal 100 (S805).

As a result, if the client terminal 100 requests a VOD channel to be viewed to the server 300 through the messaging client module 110, the server 300 confirms whether the requested channel is a channel available for the relevant terminal or not, and sends a response message. At this time, in case the VOD service is unicast, if the client terminal receives a response indicating that is the channel is available, the VOD application receiving it through a parser of the messaging client module 110 parses the stream to display it.

However, if the VOD service is multicast, the server inserts a multicast group IP corresponding to the requested channel into the response message to transmit it to the client terminal 100.

Accordingly, the parser of the messaging client module 110 in the client terminal 100 transfers the IP to the VOD application, and the VOD application receives and parses the stream by sending a message for joining the relevant multicast group using the IP, and displays it.

As a result, the TV portal services apparatus and method according to the present invention defines control messages needed for implementing several services available between the server and the client terminals. Furthermore, it suggests one service framework and message standard as shown in FIGS. 3 and 4 to collectively manage and handle several services so that HD/SD (high definition/standard definition) broadcast reception using one terminal in a home and services such as order delivery, VOD, monitoring, and information provision using the present invention are used.

As described above, the TV portal services apparatus and method according to the present invention allows management and control for various service items by providing a consistent message-based framework in the TV portal service. Furthermore, it is possible to implement new applications, which were difficult to be implemented, by providing a tool for association between individual services. It results in technical efficiency in implementing the server as well as the terminal, and implementation of flexible services by standardizing the API for the TV portal service.

1. A television portal services system, comprising:
a client terminal having at least one or more service applications for performing a plurality of different portal services based on a service message received via a network according to a user's request;
a messaging client module for:
a) converting, according to the user's request, each service request message generated from each service application to a respective client message frame format to transmit the client message frame format through a message-based protocol of the network, and
b) receiving a server message frame format for a portal service message received through the message-based protocol of the network, parsing the received server message frame format, and providing the parsed portal service message to a corresponding one of said service applications;
a messaging server module for:
a) parsing the client service message frame format received from the messaging client module through the message-based protocol of the network and thereafter outputting the parsed service request message, and
b) converting a service request and handling result message and a user informing message, provided according to the user's request from the messaging client module, to the server message frame format to transmit the server message frame format through the message-based protocol of the network to the messaging client module; and
a message server for generating the service request and handling result message, and the user informing message, according to the parsed service request message outputted from the messaging server module, provided to the messaging server module.

2. The television portal services system according to claim 1, wherein the at least one or more service applications include at least one or more of an order delivery service application, a near video-on-demand (NVOD) service application, a real video-on-demand (RVOD) service application an information providing service application, an informing service application, an electronic program guide (EPG) service application, and a digital television (DTV) service application.

3. The television portal services system according to claim 1, wherein the message frame format includes:
a message type field having message type information for classifying properties of a message transmitted and received between the server terminal and the client terminal;
a service type field having service type information for classifying television portal service types;
a data type field having data type information for classifying types of data transmitted and received between the server terminal and the client terminal;
a data field including actual data transmitted and received between the server terminal and the client terminal; and
a result type field having result type information for classifying message handling results.

4. The television portal services system according to claim 3, wherein the message type information for classifying the properties of the message includes one of at least request information (REQ), response information (REP), and informing information (INF).

5. The television portal services system according to claim 3, wherein the service type information for classifying the service types includes one of at least log in/out service (LOG) information, E-MAIL service (EML) information, order service (ORD) information, reservation service (RES) information, alarm service (ALM) information, and near video-on-demand service (NVD) information.

6. The television portal services system according to claim 3, wherein the data type information for classifying the data types includes one of at least log data (LOG), alarm data (ALM), order data (ORD), reservation data (RES), E-mail data (EML), and near video-on-demand data (NVD).

7. The television portal services system according to claim 6, wherein the log data (LOG) of the data type information includes log on (LON) and log off (LOF) data.

8. The television portal services system according to claim 6, wherein the E-mail data (EML) of the data type information includes unread mail number (UMN) data.

9. The television portal services system according to claim 6, wherein the order data (ORD) of the data type information includes one of at least settlement completion (STC), settlement confirmation (STF), receipt (RCP), post-receipt cancellation request (CAR), post-receipt cancellation confirmation (CAF), post-receipt cancellation handling (CAH), and order delivery (DLV) data.

10. The television portal services system according to claim 6, wherein the reservation data (RES) of the data type information includes one of at least reservation application (APL), reservation receipt (RCP), post-receipt cancellation request (CAR), post-receipt cancellation confirmation (CAF), and post-receipt cancellation handling (CAH) data.

11. The television portal services system according to claim 6, wherein the alarm data (ALM) of the data type information includes one of at least all alarm (ALL), unread mail alarm (UMA), reserved schedule alarm (RSA), and reserved program alarm (RPA) data.

12. The television portal services system according to claim 6, wherein the VOD data (NVD) of the data type information includes channel request (CHR) data.

13. The television portal services system according to claim 3, wherein the result type information includes one of at least success (SUC), failure (FAL), and null (NUL) information.

14. The television portal services system according to claim 1, wherein the messaging client module includes:
a message frame generating unit for generating the respective client message frame format corresponding to each of the service request messages generated from the service applications to transmit the client message frame format to the messaging server module; and
a message parsing unit for parsing the server message frame format transmitted from the messaging server module and providing the parsed portal service message to a relevant service.

15. The television portal services system according to claim 1, further comprising:
a message queue for temporarily storing the parsed portal service message from the messaging client and then transferring the portal service message to the relevant service application corresponding to the portal service to be performed.

16. The television portal services system according to claim 1, further comprising:
a FIFO (first-in first-out memory) for temporarily storing the parsed portal service message when the parsed portal service message is to be displayed on a television (TV) screen when the parsed portal service message from the messaging client module is a message requiring the user's 5 response or an informing message informing the user of a status of a requested portal service.

17. The television portal services system according to claim 16, further comprising a digital television (DTV) application and a personal computer (PC) application, wherein the parsed portal service message output from the FIFO is provided to the DTV application to be displayed as an on-screen display (OSD) in a widget form in case where a TV (television) mode is a TV view mode, and 5 is provided to the PC application to be displayed in a message box or as an icon form using an Application Program Interface (API) of an operating system (OS) when the TV mode is a personal computer (PC) screen mode.

18. The television portal services system according to claim 1, wherein the messaging server module includes:
a message frame generating unit for generating the server message frame format corresponding to the service request and handling message or the user informing message generated from the message server, and transmitting the generated the server message frame format to the messaging client module via the network; and
a message parsing unit for parsing the client service message frame format transmitted from the messaging client module and providing the parsed service request message to the message server.

19. A television portal services method, comprising the steps of:
when a service request message is generated from any of a plurality of service applications of a client terminal according to a user's request, generating a client service message frame for each generated service request message and transmitting the generated client service message frame to a server terminal through a message-based protocol of a network;
receiving the client service message frame at the server terminal through the message-based protocol and parsing the received client service message frame to extract the service request message;
generating a response and handling result message and a user informing message in response to the parsed service request message;
producing a server message frame according to the response and handling result message and the user informing message, and then transmitting the message frame from the server terminal to the client terminal through the message-based protocol of the network; and
receiving at the client terminal the server message frame and by parsing the server message frame to provide a parsed sever service message to a corresponding one or more of the service applications; and
performing the service corresponding to the parsed sever service message provided to the service application, according to the service request message.

20. The television portal services method according to claim 19, wherein the server message frame and the client service message frame, transmitted through the same message-based protocol, have the same format structure.

21. The television portal services method according to claim 19, wherein a format structure of the server message frame and the client service message frame each include:
a message type field having message type information for classifying properties of a message transmitted and received between the server terminal and the client terminal;
a service type field having service type information for classifying television portal service types;
a data type field having data type information for classifying types of data transmitted and received between the server terminal and the client terminal;
a data field including actual data transmitted and received between the server terminal and the client terminal; and
a result type field having result type information for classifying message handling results.

22. The television portal services method according to claim 19, further comprising a step of temporarily storing the parsed server service message in a message queue and then transferring the stored parsed server service message to a relevant service application when the parsed portal service message is to be displayed on a television (TV) screen.

23. The television portal services method according to claim 19, further comprising steps of:
temporarily storing the parsed server service message in a FIFO (first-in first-out memory) when the parsed server service message is a message requiring the user's response or an informing message informing the user of a status of a requested portal; and
transferring the stored parsed server service message to a relevant service application when the parsed portal service message is to be displayed on a television (TV) screen.

24. The television portal services method according to claim 23, further comprising, when the parsed server service message is to be displayed on a television (TV) screen:
providing the parsed server service message to a digital television (DTV) application to be displayed as an on-screen display (OSD) in a widget form when a TV (television) mode is a TV view mode, and
providing the parsed server service message to a personal computer (PC) application to be displayed in a message box or as an icon form using an Application Program Interface (API) of an operating system (OS) when the TV mode is a personal computer (PC) screen mode.
